(19) United States
(12) Patent Application Publication
(10) Pub. No.: US 2009/0128531 A1
(43) Pub. Date: May 21, 2009

(54) Plasma display device and driving method thereof

(76) Inventors: Choonsook Kim, Yongin-si (KR); Heehwan Kim, Yongin-si (KR); Byoungjo Chang, Yongin-si (KR); Jinyoung Jeon, Yongin-si (KR); Choelgi Son, Yongin-si (KR); Jungsu Shin, Yongin-si (KR); Sangik Lee, Yongin-si (KR); Sangmin Oh, Yongin-si (KR); Inwon Jin, Yongin-si (KR); Jiryong Jung, Yongin-si (KR); Changhoon Lim, Yongin-si (KR); Jongsu Kim, Yongin-si (KR); Jongbum Kim, Yongin-si (KR); Joonwoo Song, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 12/292,374

(22) Filed: Nov. 18, 2008

(30) Foreign Application Priority Data
Nov. 19, 2007 (KR) 10-2007-0117745

(51) Int. Cl. G09G 5/00; G09G 3/28

(52) U.S. Cl. 345/208; 345/60

(57) ABSTRACT

A plasma display device and driving method generate a control signal based on an image signal from an external source and a mode signal from a mode input unit, and output a driving waveform based on the control signal, the driving waveform used to drive a plasma display panel of the plasma display device. The driving waveform may be changed from a parent waveform mode into a child waveform mode selected from a plurality of child waveform modes defining misdischarge prevention waveforms in accordance with the mode signal.

### BACKGROUND OF THE INVENTION

1. Field of the Invention

Embodiments relate to a plasma display device and a driving method thereof. More particularly, embodiments relate to a plasma display device and a driving method thereof that store driving waveforms corresponding to misdischarge countermeasure modes and change driving waveforms into driving waveforms that compensate for misdischarge when misdischarge occurs during manufacturing or use thereof.

2. Description of the Related Art

A plasma display device is a display device using a plasma display panel that displays characters or images using plasma generated by a gas discharge. In the plasma display panel, several hundreds of thousands or several millions of pixels (discharge cells) are arranged in a matrix according to the size of the plasma display panel.

The plasma display panel of the plasma display device is driven by dividing one frame into a plurality of subfields having differing weight values. Each subfield is divided into a reset period, an address period and a sustain period. During the reset period, a discharge cell is initialized to stably perform an address discharge. During the address period, a discharge cell to be turned on or not is selected. During the sustain period, a sustain discharge is performed in the discharge cell to be turned in order to display images.

A related art plasma display device is provided with one kind of driving waveform for driving the plasma display panel. However, characteristics of the plasma display panel may be changed by various manufacturing environments. Accordingly, when a driving waveform is uniformly applied to plasma display panels manufactured under different conditions such that they have different characteristics, misdischarge may occur when characteristics of the plasma display panel are not considered.

In addition, misdischarge may occur in a related art plasma display panel because a firing voltage and discharge delay property directly affecting discharge property may change over time and/or under different operating conditions. Thus, reliability of the plasma display device may be lowered.

### SUMMARY OF THE INVENTION

Embodiments are therefore directed to a plasma display device and a driving method thereof, which substantially overcome one or more of the problems and disadvantages of the related art.

It is a feature of an embodiment to store driving waveforms corresponding to misdischarge countermeasure modes and to change driving waveforms into driving waveforms optimized for reducing misdischarge when misdischarge occurs.

It is another feature of an embodiment to change driving waveforms by simple key operation when misdischarge occurs during manufacturing.

It is yet another feature of an embodiment to change driving waveforms by remote control when misdischarge occurs during use.

At least one of the above and other features and advantages may be realized by providing a plasma display device including a controller configured to receive an image signal from an external source and a mode signal from a mode input unit, and to generate a control signal, a driver configured to receive the control signal and to output a driving waveform, and a plasma display panel configured to be driven by the driving waveform. The controller may include a mode setting controller configured to change, according to the mode signal, the driving waveform applied to the plasma display panel from a parent waveform mode into a child waveform mode. The child waveform mode may be selected from a plurality of child waveform modes defining misdischarge prevention waveforms.

The mode setting controller may include a microcontroller (MICOM) having a MICOM memory configured to store parent waveform mode data in an address of the parent waveform mode, to store a plurality of child waveform mode data in corresponding addresses of the plurality of child waveform modes, and to store the mode signal in a specific address, where the MICOM changes parent waveform mode data stored in the address of the parent waveform mode into child waveform mode data selected from the plurality of child waveform mode data according to the mode signal. The mode setting controller may include a circuit having a circuit memory configured to store and transmit child waveform mode data to the controller, the controller configured to generate the control signal for the child waveform mode data and to transmit the control signal to the driver.

The mode input unit may be a detachable key scan configured to transmit the mode signal selected by a selection button to the mode setting controller.

Parent waveform mode data may be data for generating a driving waveform of the parent waveform mode, and child waveform mode data may be data for generating a driving waveform of the child waveform mode and may include broadcasting mode information.

The mode signal may be an instruction signal for changing a driving waveform of the parent waveform mode applied to the plasma display panel into a driving waveform of the child waveform mode, and may be set during manufacturing of the plasma display device.

The mode setting controller may include a mode receiver having a receiver memory, the mode receiver configured to receive the mode signal from the mode input unit and to store the mode signal in the receiver memory, a circuit unit having an circuit memory storing the mode signal stored in the receiver memory in a specific address assigned to the circuit memory, and a MICOM including a MICOM memory storing a parent waveform mode data in an address of the parent waveform mode and stores a plurality of child waveform mode data in corresponding addresses of the plurality of child waveform modes, the MICOM configured to change the parent waveform mode data stored in the address of the parent waveform mode into child waveform mode data selected from the plurality of child waveform mode data according to the mode signal stored in the specific address of the circuit memory. The MICOM may be configured to transmit the selected child waveform mode data to the circuit unit, the circuit unit may be configured to transmit the selected child waveform data to the controller, the controller may be configured to generate a control signal for the selected child waveform mode data and to transmit the control signal to the driver.

The mode input unit may be a remote controller configured to transmit the mode signal selected by a selection button to the mode setting controller.

Parent waveform mode data may be data for generating a driving waveform of the parent waveform mode, and the child waveform mode data may be data for generating a driving waveform of the child waveform mode and includes broadcasting mode information.

The driving waveform generated by the driver may include a reset period, an address period and a sustain period, and the driving waveforms of the plurality of child waveform modes are driving waveforms changed from at least one of waveforms applied to the plasma display panel during the reset period, the address period and the sustain period for the driving waveform of the parent waveform mode.

At least one of the above and other features and advantages may be realized by providing a driving method of a plasma display device including a plasma display panel driven by a driving waveform applied from a driver controlled by a controller connected to a mode input unit, the method including providing a mode signal for a misdischarge countermeasure mode of the plasma display panel, and changing the driving waveform from a parent waveform mode into a child waveform mode selected from a plurality of child waveform modes defining misdischarge countermeasure waveforms according to the mode signal.

Providing the mode signal may include transmitting the mode signal from the mode input unit to a mode setting controller in the controller, and storing the mode signal in a memory in the mode setting controller.

Storing the mode signal may include storing the mode signal in a specific address assigned to a microcomputer (MICOM) memory by a MICOM the mode setting controller, the MICOM memory storing the parent waveform mode data in an address of the parent waveform mode and the plurality of child waveform mode data in corresponding addresses of the plurality of the child waveform modes.

Changing the driving waveform may include changing the parent waveform mode data stored in the address of the parent waveform mode into the selected child waveform mode data corresponding to the mode signal stored in the specific address by the MICOM by turning off and on a power source of the plasma display device, storing the selected child waveform mode data in a circuit memory of a circuit unit included in the mode setting controller and connected to the MICOM, generating a control signal for the selected child waveform mode data and transmitting the control signal from the controller to the driver, and applying a driving waveform generated according to the control signal for the selected child waveform mode data to the plasma display panel.

Transmitting the mode signal may include transmitting the mode signal directly to the MICOM.

Storing the mode signal may include storing the mode signal in a receiver memory included in a mode receiver in the mode setting controller.

Changing the driving waveform may include storing the mode signal in a specific address assigned to an circuit memory of the circuit unit included in the mode setting controller and connected to the mode receiver by turning off and on a power source of the plasma display device, and reading out the mode signal stored in the specific address of the circuit memory and changing the parent waveform mode data stored in the address of the parent waveform mode assigned to the MICOM memory into a child waveform mode data corresponding to the mode signal by the MICOM included in the mode setting controller and connected to the circuit unit, storing the changed child waveform mode data in the circuit memory of the circuit unit included in the mode setting controller and connected to the MICOM, generating a control signal for the changed child waveform mode data and transmitting the control signal to the driver by the controller, and applying a driving waveform generated according to the control signal for the changed child waveform mode data to the plasma display panel by the driver.

Transmitting the mode signal may include transmitting the mode signal wirelessly to the mode receiver.

The driving waveform of the child waveform mode may be a driving waveform converted from the waveform applied to the plasma display panel during the reset period, address period and sustain period of at least one subfields of a plurality of subfields divided from one frame for the driving waveform of the parent waveform mode.

The driving method may include identifying whether using a driving waveform of the selected child waveform reduces misdischarge of the plasma display panel.

The driving method may include repeating, using a different mode signal, the changing when misdischarge of the plasma display panel still occurs.

### BRIEF DESCRIPTION OF THE DRAWINGS

The above and other features and advantage will become more apparent to those of ordinary skill in the art by describing in detail exemplary embodiments with reference to the attached drawings, in which:

FIG. 1 illustrates a block diagram of a plasma display device according to one exemplary embodiment of the present invention;

FIG. 2 illustrates a waveform diagram of a parent waveform mode applied to the plasma display panel of FIG. 1;

FIG. 3 illustrates an exemplary diagram of an example of an address where a child waveform mode data is assigned;

FIG. 4 illustrates an exemplary diagram of an example of a construction of instruction for selecting a child waveform mode;

FIGS. 5a and 5b illustrates exemplary diagrams of driving waveforms of the child waveform mode;

FIG. 6 illustrates a block diagram of a detailed construction of a mode setting controller of FIG. 1 according to a first embodiment;

FIG. 7 illustrates a flow chart of a driving method of the plasma display device according to the first embodiment;

FIG. 8 illustrates a block diagram of a detailed construction of a waveform mode setting unit of a plasma display device according to a second embodiment; and

FIG. 9 illustrates a flow chart of a driving method of the plasma display device according to the second embodiment.

### DETAILED DESCRIPTION OF THE INVENTION

Korean Patent Application No. 10-2007-0117745, filed on Nov. 19, 2007, in the Korean Intellectual Property Office, and entitled: “Plasma Display Device and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Form Paragraph for Wall Charges

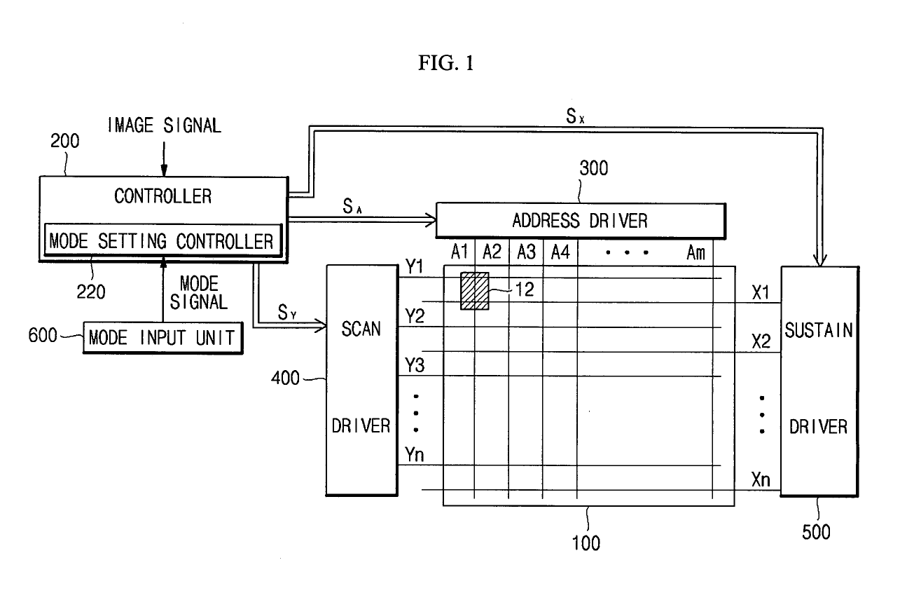

FIG. 1 illustrates a block diagram of a plasma display device according to one exemplary embodiment of the present invention.

The plasma display device may include a plasma display panel 100, a controller 200, a plurality of drivers 300, 400 and 500, and a mode input unit 600. The controller 200 may include a mode setting controller 220. The drivers 300, 400, and 500 may correspond to an address driver 300, a scan driver 400, and a sustain driver 500. The plasma display device may improve misdischarge of the plasma display panel 100 by changing a driving waveform applied to the plasma display panel 100 into a driving waveform optimized for a misdischarge countermeasure mode when misdischarge occurs in the plasma display panel during manufacturing or use.

Referring to FIG. 1, the plasma display panel 100 may include a plurality of address electrodes (A1 to Am) (hereinafter referred to as “A electrodes”) extending in a column direction, a plurality of sustain electrodes (X1 to Xn) (hereinafter referred to as “X electrodes”) and a plurality of scan electrodes (Y1 to Yn) (hereinafter referred to as “Y electrodes”) extending in a row direction so as to form pairs with each other. Generally, each X electrode (X1 to Xn) corresponds to each Y electrode (Y1 to Yn). The X electrode (X1 to Xn) and Y electrode (Y1 to Yn) may perform display operation for displaying images in a sustain period. The X electrode (X1 to Xn) and Y electrode (Y1 to Yn) may be arranged perpendicularly to the A electrode (A1 to Am). A discharge space at the intersection of the A electrode (A1 to Am), X electrode (X1 to Xn), and Y electrode (Y1 to Yn) forms a discharge cell 12. Such a structure of the plasma display panel 100 is merely an example, and driving waveforms described below according to embodiments may be applied to plasma display panels of different structures.

The controller 200 may divide one frame into a plurality of subfields. Each subfield may include a reset period, an address period, and a sustain period. The controller 200 may receive image signals, e.g., R, G, B data, and a synchronization signal from an external device, and may output an address electrode driving control signal SA, a scan electrode driving control signal SY, and a sustain electrode driving control signal SX.

The mode setting controller 220 included in the controller 200 may control a driving waveform applied to the plasma display panel 100 to change from a parent waveform mode, i.e., a standard of default mass-production waveform, into a misdischarge countermeasure waveform selected from a plurality of child waveform modes defined according to a mode signal transmitted from a mode input unit 600, as described below. The mode signal is an instruction signal for changing the driving waveform of the parent waveform mode applied to the plasma display panel 100 into a misdischarge countermeasure waveform selected from the plurality of child waveform modes when misdischarge occurs in the plasma display panel 100. In FIG. 1, the mode setting controller 220 is included in the controller 200, but may be separate. The mode setting controller 220 will be described in detail later.

The address driver 300 may generate a display data signal by processing the address electrode driving control signal SA from the controller 200 and may apply the display data signal to the A electrodes. The scan driver 400 may generate a scan pulse by processing the scan electrode driving control signal SY from the controller 200 and may apply the scan pulse to the Y electrodes. The sustain driver 500 may generate a sustain pulse by processing the sustain electrode driving control signal SX from the controller 200 and may apply the sustain pulse to the X electrodes. The driving control signals SA, SY, and SX may initially be control signals for the driving waveform of the parent waveform mode.

The mode input unit 600 may generate the mode signal transmitted to the mode setting controller 220 as described above. The mode input unit 600 may use a key scan detachable during manufacturing of the plasma display device. The key scan may include a selection button serving as an instruction input unit. A process operator may transmit the mode signal to the mode setting controller 220 to select any of the plurality of child waveform modes, which are misdischarge countermeasure modes, as a driving waveform of the plasma display panel 100 by using the selection button when a misdischarge occurs in the plasma display panel 100 during manufacturing, e.g., during testing of a assembled plasma display device.

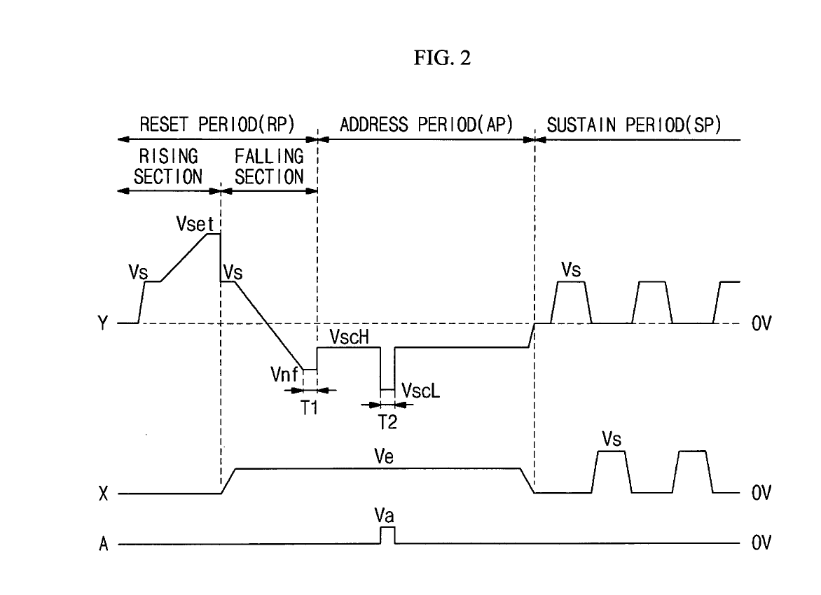

FIG. 2 illustrates a waveform diagram of the parent waveform mode applied to the plasma display panel of FIG. 1.

Driving waveforms applied to the Y, X and A electrodes forming a single discharge cell will be explained for convenience. A discharge cell in which a sustain discharge occurs in a sustain period is defined as a light emitting discharge cell, and a discharge cell in which a sustain discharge does not occur in a sustain period is defined as a non-emitting discharge cell.

Referring to FIG. 2, the plasma display panel 100 may display a predetermined image by subsequently performing a reset period (RP), an address period (AP), and a sustain period (SP) in one subfield.

The reset period (RP) may include a rising section and a falling section.

In the rising section of the reset period (RP), a rising reset pulse rising gradually to a voltage Vset from a voltage Vs may be applied to the Y electrode. At this time, a ground voltage (0V in FIG. 2) may be applied to the X and A electrodes. Then, a weak discharge occurs between the Y and X electrodes, while a weaker discharge occurs between the Y and A electrodes. Negative (−) wall charges are formed on the Y electrode and positive (+) wall charges are formed on the A electrode and X electrode by the weak discharges. When the voltage of the Y electrode gradually changes as shown in FIG. 2, a weak discharge occurs in the discharge cell. Thus, wall charges are formed, thereby maintaining a condition of firing voltage by sum of an externally applied voltage and a wall voltage of the discharge cell. Every discharge cell should be initialized in the reset period, and the voltage Vset may be high enough to cause a discharge in every discharge cell.

In the subsequent falling section of the reset period (RP), a falling reset pulse falling gradually to a voltage Vnf from the voltage Vs may be applied to the Y electrode while a voltage applied to the X electrode is maintained at a voltage Ve. At this time, a ground voltage (0V) may be applied to the A electrode. Then, while the voltage of the Y electrode decreases, a weak discharge occurs between the Y electrode and the X electrode, and between the Y electrode and the A electrode. Simultaneously, the negative (−) wall charges formed on the Y electrode and the positive (+) wall charges formed on the X and A electrodes are erased. Generally, a magnitude of |Vnf−Ve| is set to a value near a firing voltage between the Y and X electrodes. Then, a wall voltage between the Y electrode and X electrode becomes almost 0V, thereby preventing a misdischarge from occurring during the sustain period in a non-selected discharge cell. In FIG. 2, the reset pulse waveform is shown in ramp form, but other reset pulse waveforms performing the same or similar function may be used.

Next, in the subsequent address period (AP), while the voltage Ve is applied to the X electrode, a scan low pulse having a voltage VscL may be sequentially applied to the plurality of Y electrodes for selecting a light emitting discharge cell. At this time, a voltage Va may be applied to the A electrode of the selected light emitting discharge cell of the plurality of discharge cells formed by the Y electrodes applied with the voltage VscL. Then, positive (+) wall charges are formed on the Y electrode and negative (−) wall charges are formed on the X electrode. Further, negative (−) wall charges are also formed on the A electrode. The voltage VscL may be equal to or less than the voltage Vnf. A voltage VscH, higher than the voltage VscL, may be applied to the Y electrode not receiving the voltage VscL, and the ground voltage of 0V may be applied to the A electrode of a non-emitting discharge cell.

For performing such an operation, the scan driver 400 may select a Y electrode to be applied with the scan low pulse of the voltage VscL of the Y electrodes (Y1 to Yn). For example, the Y electrode may be selected row by row. When one Y electrode is selected, the address driver 300 may select a light emitting discharge cell of discharge cells formed by the Y electrodes. That is, the address driver 300 may select a discharge cell to be applied with an address pulse of the voltage Va of the A electrodes (A1 to Am). Like this, in the address period (AP), the discharge cell in a state of non-emitting is set to a light emitting discharge cell by forming wall charges on the corresponding discharge cell by discharging the discharge cell.

Next, in the sustain period (SP), a sustain pulse alternatively having the voltage Vs and a ground voltage (0V) may be applied to the Y and X electrodes respectively in phases opposite to each other so as to generate a sustain discharge between the Y and X electrodes. Application of the sustain pulse to the Y electrode and the X electrode are repeated by the number corresponding to the weight value that the corresponding subfield displays. In FIG. 2, the voltage Vs and the ground voltage (0V) respectively serve as high and low levels of the sustain pulse, but these levels are not limited thereto. For example, the low level of the sustain pulse may be used as a negative sustain voltage—Vs.

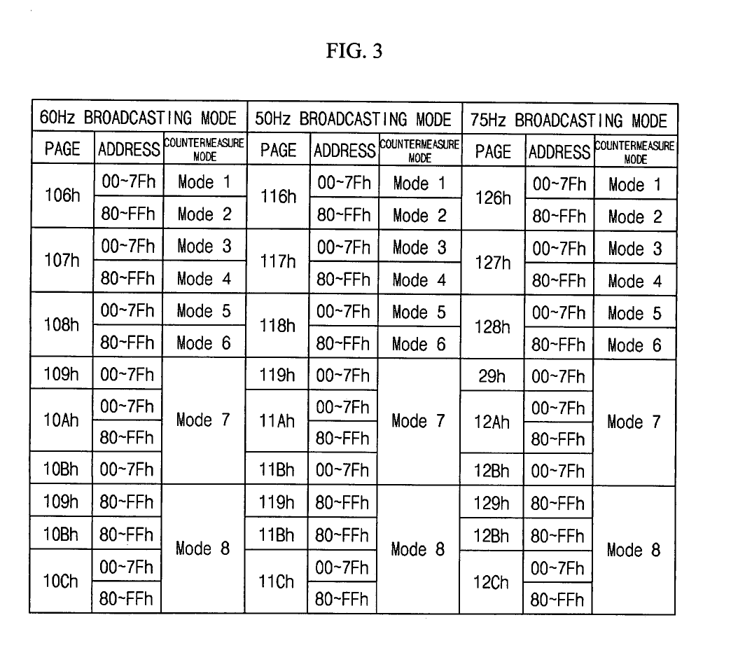

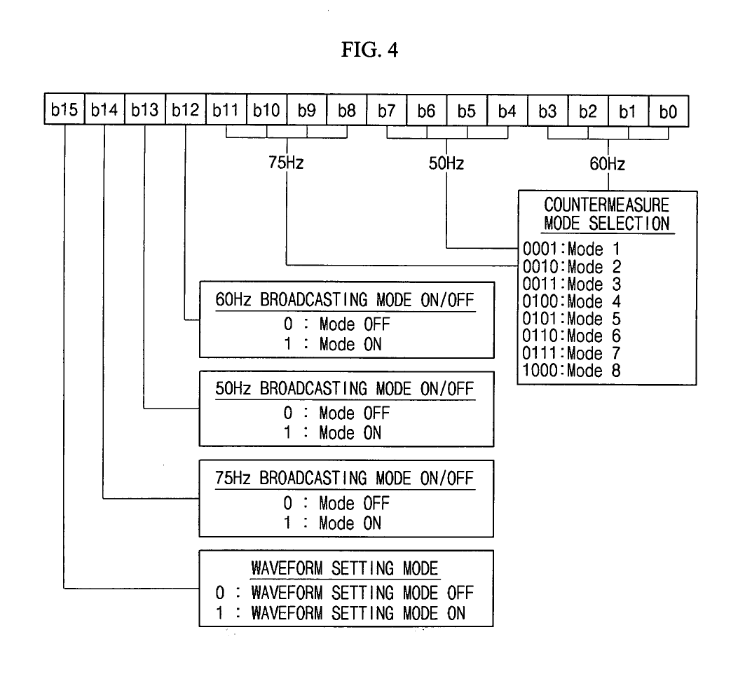

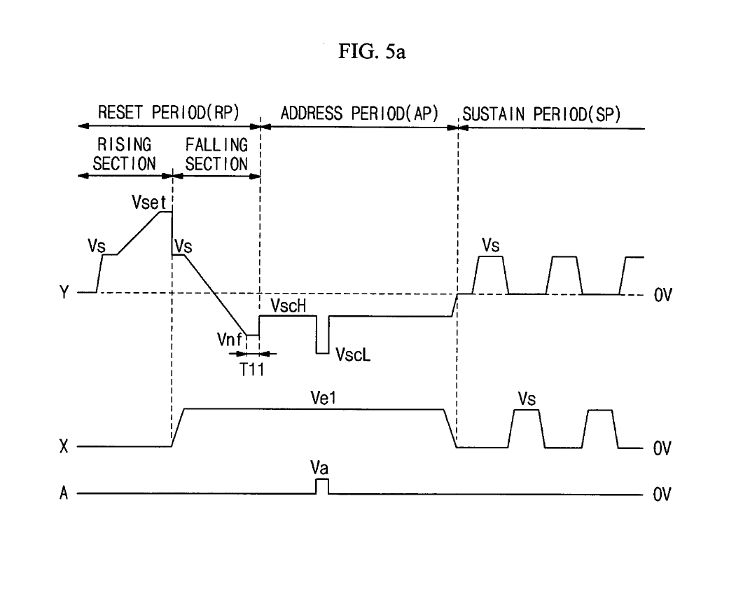

When the plasma display panel 100 misdischarges, the driving waveform of the parent waveform mode shown in FIG. 2 may be changed to a driving waveform of a selected child waveform mode according to the mode signal, as discussed with reference to FIGS. 3 to 5b. FIG. 3 illustrates the plurality of child waveform modes according to an embodiment. FIG. 4 illustrates storage of the child waveform modes according to an embodiment. FIGS. 5a and 5b illustrate specific examples of a driving waveform of a selected child waveform mode.

As shown in FIG. 3, the plurality of child waveform mode data may be subdivided according to misdischarge countermeasure mode information of the plasma display panel 100 and broadcasting mode information, and may be stored in the addresses of the plurality of child waveform mode. Thus, misdischarge of the plasma display panel 100 may be variously compensated according to the broadcasting mode. The broadcasting modes of the image signals may include a broadcasting mode having a 60 Hz refresh rate, a broadcasting mode having a 50 Hz refresh rate, and a broadcasting mode having a 75 Hz refresh rate, although other broadcasting modes may be employed.

An instruction for storing the mode signal received via the mode input unit 600 from the user in a specific address may be constructed as shown in FIG. 4. Referring to FIG. 4, 16 bits may be assigned to a specific address and a function of generally turning on/off a waveform setting mode may be designated to a bit b15 that is a most significant bit (MSB) of the 16 bits, and functions of turning on/off a misdischarge countermeasure mode according to each broadcasting mode may be designated to bits b14 to b12, and 4 bits may be assigned to each of bits b11 to b0, thereby setting eight misdischarge countermeasure modes according to each broadcasting mode.

Examples of child driving waveforms are illustrated in FIGS. 5a and 5b. Herein, the driving waveforms shown in FIGS. 5a and 5b are those of broadcasting modes having a vertical frequency or refresh rate of 60 Hz, for example.

The driving waveform of the child waveform mode shown in FIG. 5a may be formed by changing a waveform applied to the Y electrode during the falling section of the reset period (RP) for the driving waveform of the parent waveform mode shown in FIG. 2. For example, in FIG. 5a, a period T11 during which the voltage Vnf is applied to the Y electrode during the falling section of the reset period (RP) may be shorter in the child waveform mode than a corresponding period T1 in the parent waveform mode in FIG. 2. The driving waveform of the child waveform mode shown in FIG. 5a is a misdischarge countermeasure waveform for preventing a low address discharge caused by excessive loss of wall charges in a reset discharge under high temperature environment. The driving waveform of the child waveform mode properly distributes wall charges by reducing the excessive loss of wall charges distributed on the electrode in the reset discharge generated during the falling section of the reset period (RP) under high temperature environment, thereby reducing occurrence of the misdischarge in the subsequent address discharge.

The driving waveform of the child waveform mode shown in FIG. 5b may be formed by changing a waveform applied to the Y electrode during the address period (AP) for the driving waveform of the parent waveform mode shown in FIG. 2. For example, in FIG. 5b, a period T21 during which the voltage VscL is applied to the Y electrode during the address period (AP) may be longer in the child waveform mode than a corresponding period T2 of the parent waveform mode shown in FIG. 2. The driving waveform of the child waveform mode shown in FIG. 5b is a misdischarge countermeasure waveform for preventing a low address discharge caused by increase of a discharge delay that may occur with time. The driving waveform of the child waveform mode makes an address discharge time sufficiently longer, thereby reducing occurrence of the misdischarge of the address discharge.

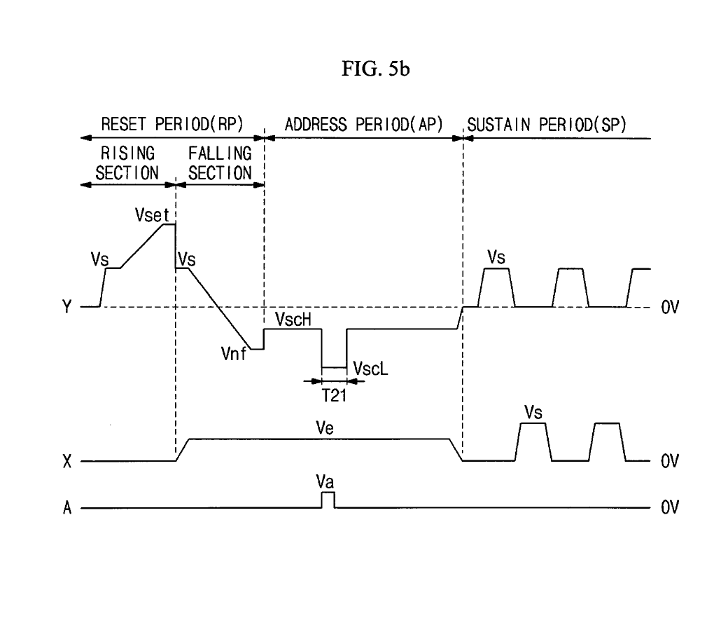

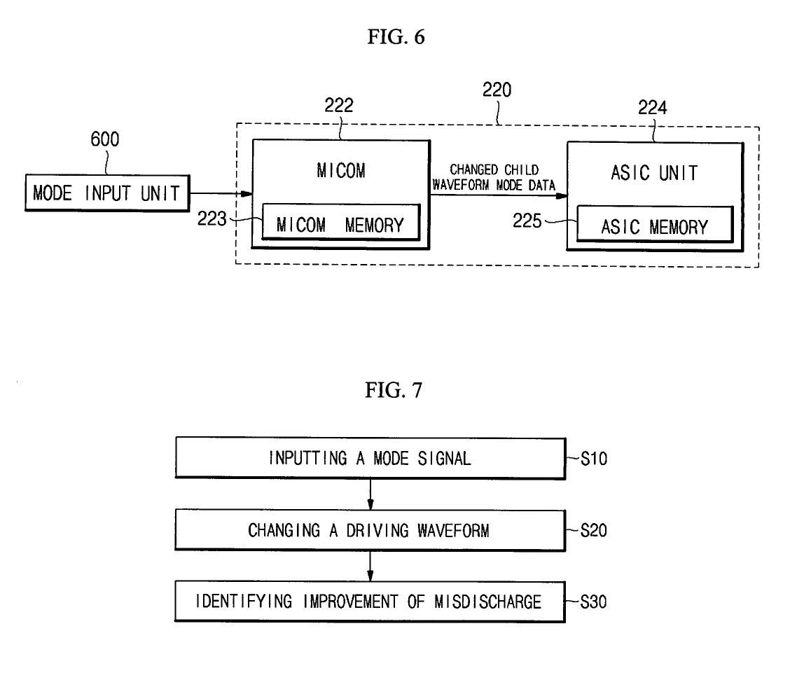

FIG. 6 illustrates a block diagram of a detailed construction of the mode setting controller 220 of FIG. 1 according to a first embodiment. FIG. 7 illustrates a flowchart of a driving method of the plasma display device according to the first embodiment.

Referring to FIG. 6, the mode setting controller 220 may include a microcomputer (MICOM) 222 and a circuit unit, e.g., an application specific integrated circuit (ASIC) unit 224.

The MICOM 222 may include a MICOM memory 223. The MICOM 222 may receive a mode signal via the mode input unit 600 from a user, e.g., a manufacturing technician or an end user, and may store the mode signal in the MICOM memory 223. The MICOM memory 223 may include a flash memory. The MICOM memory 223 may be divided into a plurality of addresses so as to store parent waveform mode data in an address of the parent waveform mode and to store a plurality of child waveform mode data in addresses of the plurality of child waveform mode. Herein, the parent waveform mode data is data for generating a driving waveform of the parent waveform mode, and the child waveform mode data is data for generating a driving waveform of the child waveform mode.

The MICOM memory 223 may store the mode signal received by the MICOM 222 in a specific address. An instruction for storing the mode signal received via the mode input unit 600 from the user in the specific address of the MICOM memory 223 may be constructed as shown in FIG. 4, for example. The MICOM 222 may communicate with the mode input unit 600 via an universal asynchronous receiver/transmitter (UART) for receiving the mode signal from the mode input unit 600. When the mode signal is stored in the specific address, the MICOM 222 may change parent waveform mode data stored in the address of the parent waveform mode into child waveform mode data.

The ASIC unit 224 may include an ASIC memory 225. The ASIC memory 225 may include a random access memory (RAM). The ASIC unit 224 may receive the child waveform mode data stored in the address of the parent waveform mode of the MICOM memory 223 and may store the child waveform mode data in the ASIC memory 225. The ASIC unit 224 may enable the controller 200 to generate a control signal for the child waveform mode data and to transmit the control signal to the drivers 300, 400, and 500. Then, the drivers 300, 400, and 500 may generate a driving waveform of the child waveform mode according to the control signal and apply the driving waveform to the plasma display panel 100. Thus, the plasma display panel 100 may be driven by the driving waveform of the child waveform mode that is the misdischarge countermeasure mode, thereby reducing misdischarge of the plasma display panel 100.

As described above, the plasma display device may improve the misdischarge by previously storing the driving waveforms corresponding to the misdischarge countermeasure modes and simply changing the driving waveform of the plasma display panel into the driving waveform of the child waveform mode defined as the misdischarge countermeasure mode, e.g., using the key scan when the misdischarge occurs during manufacturing of the plasma display device. Thus, productivity is improved by reducing defective products in the manufacturing process.

FIG. 7 illustrates a flow chart of the driving method of the plasma display device in accordance with the first embodiment. Referring to FIG. 7, the driving method of the plasma display device may include operations of inputting a mode signal (S10), changing a driving waveform (S20), and identifying whether a misdischarge is improved (S30).

First, a parent waveform mode, defined as a standard or default mass-production waveform, and a plurality of child waveform modes, defined as misdischarge countermeasure waveforms, may be stored in the controller 200 as driving waveforms to be applied to the plasma display panel 100. In an implementation, misdischarge of the plasma display panel 100 may be detected by a naked eye test during manufacturing process of the plasma display device under a condition that a present driving waveform applied to the plasma display panel 100 is set as the parent waveform mode.

In operation S10, the mode input unit 600 is connected to the mode setting controller 220, particularly, to the MICOM 222 and a worker transmits a mode signal for a misdischarge countermeasure mode of the plasma display panel 100 to the MICOM 222 through the mode input unit 600. Herein, the mode signal is stored in a specific address of the MICOM memory 223 of the MICOM 222.

Next, in operation S20, the mode setting controller 220 changes a driving waveform applied to the plasma display panel 100 from the parent waveform mode into any one of a plurality of child waveform modes defined as a misdischarge countermeasure waveform according to the mode signal received from the mode input unit 600.

Particularly, when the plasma display device is turned off and then turned on, the MICOM 222 checks a state, e.g., ON/OFF, of a waveform setting function from a mode signal stored in a specific address of the MICOM memory 223 during an initializing section. If the waveform setting function is turned on, the MICOM 222 checks a state, e.g., ON/OFF, of a broadcasting mode. If the waveform setting function is turned off, the MICOM 222 transmits a parent waveform mode data stored in an address of the parent waveform mode to the ASIC unit 224 directly.

Next, the MICOM 222 checks a misdischarge countermeasure mode of the corresponding broadcasting mode and changes parent waveform mode data stored in the address of the parent waveform mode into child waveform mode data for the misdischarge countermeasure mode of the corresponding broadcasting mode. Then, the MICOM 222 may transmit the child waveform mode data to the ASIC unit 224, and the ASIC unit 224 may store the child waveform mode data in the ASIC memory 225. Then, the controller 200 may generate a control signal for the child waveform mode data stored in the ASIC memory 225 of the ASIC unit 224, and may transmit the control signal to the drivers 300, 400 and 500. Next, the drivers 300, 400, and 500 may generate a driving waveform of the child waveform mode changed by the control signal for the child waveform mode data, and apply the driving waveform to the plasma display panel 100. Accordingly, the plasma display panel 100 may be driven by the driving waveform of the child waveform mode.

Next, in operation S30, misdischarge of the plasma display panel 100 driven by the driving waveform of the child waveform mode data may be assessed. In operation S30, misdischarge of the plasma display panel 100 driven by the driving waveform of the child waveform mode may be identified, e.g., by a naked eye test. If misdischarge of the plasma display panel 100 appears to be improved, manufacturing of the plasma display device may proceed. If misdischarge of the plasma display panel 100 does not appear to improve, operations S10 to S30 may be repeated, e.g., with a different mode signal, until misdischarge of the plasma display panel 100 is improved.

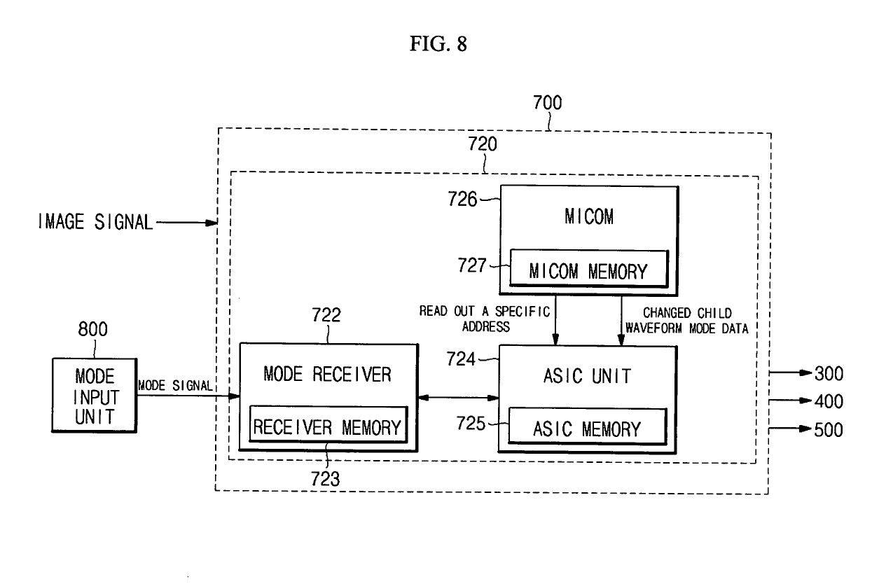

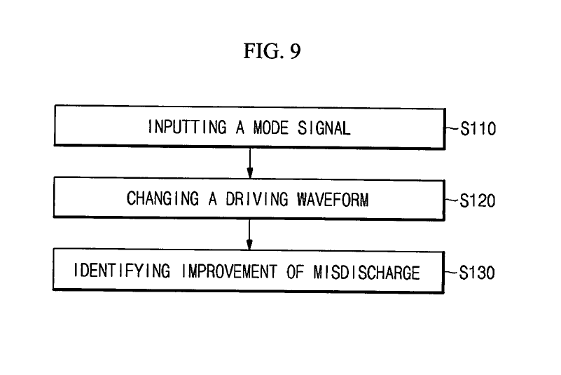

Next, a plasma display device according to a second embodiment of the present invention will be explained below with reference to FIGS. 8 and 9. FIG. 8 illustrates a block diagram of a detailed construction of the mode setting unit of the plasma display device. FIG. 9 illustrates a flow chart of the driving method in accordance with the second embodiment.

The plasma display device has the same construction as the plasma display device according to the first embodiment described above except for construction of a mode setting controller and a mode input unit. Therefore, the same drawing reference numerals are used for the same elements and overlapping explanations will not be repeated. The mode setting controller and the mode input unit will be mainly explained in the embodiment.

As illustrated in FIG. 8, the plasma display device may include the plasma display panel 100, a controller 700, the plurality of drivers 300, 400, and 500, and the mode input unit 800. The controller 700 may include a mode setting controller 720. The plasma display device may improve a misdischarge of the plasma display panel 100 by selecting a driving waveform optimized for a misdischarge countermeasure mode and applying the driving waveform to the plasma display panel 100 when the misdischarge occurs during the use of the plasma display panel.

The functions of the controller 700 and the mode setting controller 720 may be the same as those of the controller 200 and the mode setting controller 220 shown in FIG. 6. The mode setting controller 720 of the controller 700 and the mode setting controller 220 of the controller 200 may differ in constitution and may use different specific operations to achieve the function.

Referring to FIG. 8, the mode setting controller 720 may include a mode receiver 722, an ASIC unit 724 and a MICOM 726.

The mode receiver 722 may include a receiver memory 723. The mode receiver 722 may receive a mode signal via the mode input unit 800 from a user, i.e., an operator, of the plasma display device and may store the mode signal in the receiver memory 723. Herein, the receiver memory 723 may include an electrically erasable programmable read only memory (EEPROM). The mode receiver 722 may communicate with the mode input unit 800 via an I-square-C (I2C) communication for receiving the mode signal from the mode input unit 800. Construction of an instruction for storing the mode signal received through the mode input unit 800 from the user in the receiver memory 723 may be the same as the instruction for storing the mode signal received via the mode input unit 600 from the user in the specific address of the MICOM memory 223 of the MICOM 222, e.g., as illustrated in FIG. 4.

The ASIC unit 724 may include an ASIC memory 725. The ASIC unit 724 may receive the mode signal stored in the receiver memory 723 of the mode receiver 722 and may store the mode signal in a specific address of the ASIC memory 725. The ASIC memory 725 may include a RAM.

The MICOM 726 may include a MICOM memory 727. The MICOM 726 may be connected to the ASIC unit 724. A construction of the MICOM memory 727 may be the same as that of the MICOM memory 223 of the MICOM 222 illustrated FIG. 6. The MICOM 726 may check a mode signal stored in a specific address of the ASIC memory 725 of the ASIC unit 724 and may change parent waveform mode data stored in an address of a parent waveform mode into child waveform mode data when the plasma display device is used. However, the MICOM 726 is not directly connected to the mode input unit 800, as is the MICOM 222 and the mode input unit 600. Thus, the mode signal for the misdischarge countermeasure mode of the plasma display panel 100 may be provided to the MICOM 726 via the mode receiver 722.

The MICOM 726 may transmit the child waveform mode data to the ASIC unit 724. Then, the ASIC unit 724 may store the child waveform mode data in the ASIC memory 725. The ASIC unit 724 may enable the controller 700 to generate a control signal for the child waveform mode data and to transmit the control signal to the drivers 300, 400, and 500. Then, the drivers 300, 400, and 500 may generate a driving waveform of the child waveform mode according to the control signal for the child waveform mode data and apply the driving waveform to the plasma display panel 100. Thus, the plasma display panel 100 may be driven by the driving waveform of the child waveform mode that is the misdischarge countermeasure mode, thereby improving the misdischarge of the plasma display panel 100.

As described above, the mode input unit 800 may generate the mode signal transmitted to the mode setting controller 720, more particularly, to the mode receiver 722, and may use a remote controller capable of a wireless communication. The remote controller may include a selection button serving as an instruction input unit. The user, e.g., an end user or a repair technician, may transmit the mode signal to the mode setting controller 720 to select any one of the plurality of child waveform modes, i.e., misdischarge countermeasure modes, as a driving waveform of the plasma display panel 100 using the selection button when a misdischarge occurs in the plasma display panel 100 during use of the plasma display device.

As described above, the plasma display device may improve misdischarge by storing driving waveforms corresponding to the misdischarge countermeasure modes and changing the driving waveform of the plasma display panel into a selected driving waveform of the child waveform mode defined as the misdischarge countermeasure using the remote controller when misdischarge occurs, e.g., due to environmental conditions or time. Thus, reliability for the plasma display device may be improved.

FIG. 9 illustrates a flow chart of the driving method of the plasma display device according to the second embodiment. Referring to FIG. 9, the driving method of the plasma display device may include operations of inputting a mode signal (S110), changing a driving waveform (S120) and identifying whether a misdischarge is improved (S130).

First, a parent waveform mode defined as a normal mass-production waveform and a plurality of child waveform modes defined as misdischarge countermeasure waveforms are stored in the controller 700 as a driving waveform applied to the plasma display panel 100. It is assumed that a present driving waveform applied to the plasma display panel 100 is set as the parent waveform mode, and a user of the plasma display device identified misdischarge of the plasma display panel 100 and requested an operator of the plasma display device to repair of the plasma display device.

In operation S110, the operator transmits a mode signal for a misdischarge countermeasure mode of the plasma display panel 100 to the mode setting controller 720, particularly, to the mode receiver 722 through wireless communication via the mode input unit 800. Herein, the mode signal may be stored in the receiver memory 723 of the mode receiver 722.

Next, in the operation S120, the mode setting controller 720 may change a driving waveform applied to the plasma display panel 100 from the parent waveform mode into any one of a plurality of child waveform modes defined as a misdischarge countermeasure waveform according to the mode signal received from the mode input unit 800.

Particularly, when the plasma display device is turned off and then turned on, the mode signal stored in the receiver memory 723 of the mode receiver 722 may be stored in a specific address assigned to the ASIC memory 725 of the ASIC unit 724 through I2C communication between the mode receiver 722 and the ASIC unit 724. The MICOM 726 may read out the mode signal stored in the specific address assigned to the ASIC memory 725 of the ASIC unit 724 checks a state, e.g., ON/OFF, of a waveform setting function from the mode signal. If the waveform setting function is turned on, the MICOM 726 checks a state, e.g., ON/OFF, of a broadcasting mode. If the waveform setting function is turned off, the MICOM 726 may transmit the parent waveform mode data stored in an address of the parent waveform mode to the ASIC unit 724.

Next, the MICOM 726 may check a misdischarge countermeasure mode of the corresponding broadcasting mode and may change parent waveform mode data stored in the address of the parent waveform mode into child waveform mode data for the misdischarge countermeasure mode of the corresponding broadcasting mode. Then, the MICOM 726 may transmit the child waveform mode data to the ASIC unit 724, and the ASIC unit 724 may store the child waveform mode data in the ASIC memory 725. Then, the controller 700 may generate a control signal for the child waveform mode data stored in the ASIC memory 725 of the ASIC unit 724, and may transmit the control signal to the drivers 300, 400, and 500. Next, the drivers 300, 400, and 500 may generate a driving waveform of the child waveform mode changed by the control signal for the selected child waveform mode data, and apply the driving waveform to the plasma display panel 100. Accordingly, the plasma display panel 100 may be driven by the driving waveform of the child waveform mode.

Next, in operation S130, misdischarge of the plasma display panel 100 driven by the driving waveform of the child waveform mode is examined. For this, in operation S130, misdischarge of the plasma display panel 100 driven by the driving waveform of the child waveform mode may be analyzed, e.g., by a naked eye test. If misdischarge of the plasma display panel 100 is improved, the operator may return the plasma display device to the user of the plasma display device for further use. If misdischarge of the plasma display panel 100 is not improved, the operations S110 to S130 may be repeated, e.g., using a different mode signal, until misdischarge of the plasma display panel 100 is improved.

As described above, the plasma display device and the driving method thereof according to embodiments may produce the following effects.

First, misdischarge may be prevented by simply changing the driving waveform of the plasma display panel into the driving waveform of the child waveform mode defined as the misdischarge countermeasure mode, e.g., using a key scan, when misdischarge occurs in the plasma display panel during manufacturing. Thus, productivity may be improved by reducing defective plasma display devices.

Second, misdischarge may be prevented by changing the driving waveform of the plasma display panel into the driving waveform of the child waveform mode defined as the misdischarge countermeasure mode using, e.g., a remote controller, when the misdischarge occurs in the plasma display panel during use of the plasma display device. Thus, reliability and/or lifetime of the plasma display device may be improved.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device, comprising:
a controller configured to receive an image signal from an external source and a mode signal from a mode input unit, and to generate a control signal;
a driver configured to receive the control signal and to output a driving waveform; and
a plasma display panel configured to be driven by the driving waveform, wherein:
the controller includes a mode setting controller configured to change, according to the mode signal, the driving waveform applied to the plasma display panel from a parent waveform mode into a child waveform mode, and
the child waveform mode is selected from a plurality of child waveform modes defining misdischarge prevention waveforms.

2. The plasma display device as claimed in claim 1, wherein the mode setting controller comprises:
a microcontroller (MICOM) having a MICOM memory configured to store parent waveform mode data in an address of the parent waveform mode, to store a plurality of child waveform mode data in corresponding addresses of the plurality of child waveform modes, and to store the mode signal in a specific address, where the MICOM changes parent waveform mode data stored in the address of the parent waveform mode into child waveform mode data selected from the plurality of child waveform mode data according to the mode signal, and
a circuit having a circuit memory configured to store and transmit child waveform mode data to the controller, the controller configured to generate the control signal for the child waveform mode data and to transmit the control signal to the driver.

3. The plasma display device as claimed in claim 2, wherein the mode input unit is a detachable key scan configured to transmit the mode signal selected by a selection button to the mode setting controller.

4. The plasma display device as claimed in claim 2, wherein parent waveform mode data is data for generating a driving waveform of the parent waveform mode, and child waveform mode data is data for generating a driving waveform of the child waveform mode and includes broadcasting mode information.

5. The plasma display device as claimed in claim 1, wherein:
the mode signal is an instruction signal for changing a driving waveform of the parent waveform mode applied to the plasma display panel into a driving waveform of the child waveform mode; and
the mode signal is set during manufacturing of the plasma display device.

6. The plasma display device as claimed in claim 1, wherein the mode setting controller comprises:
a mode receiver having a receiver memory, the mode receiver configured to receive the mode signal from the mode input unit and to store the mode signal in the receiver memory;
a circuit unit having an circuit memory storing the mode signal stored in the receiver memory in a specific address assigned to the circuit memory; and
a MICOM including a MICOM memory storing a parent waveform mode data in an address of the parent waveform mode and stores a plurality of child waveform mode data in corresponding addresses of the plurality of child waveform modes, the MICOM configured to change the parent waveform mode data stored in the address of the parent waveform mode into child waveform mode data selected from the plurality of child waveform mode data according to the mode signal stored in the specific address of the circuit memory, wherein:
the MICOM is configured to transmit the selected child waveform mode data to the circuit unit,
the circuit unit is configured to transmit the selected child waveform data to the controller, and
the controller is configured to generate a control signal for the selected child waveform mode data and to transmit the control signal to the driver.

7. The plasma display device as claimed in claim 6, wherein the mode input unit is a remote controller configured to transmit the mode signal selected by a selection button to the mode setting controller.

8. The plasma display device as claimed in claim 6, wherein the parent waveform mode data is data for generating a driving waveform of the parent waveform mode, and the child waveform mode data is data for generating a driving waveform of the child waveform mode and includes broadcasting mode information.

9. The plasma display device as claimed in claim 1, wherein the driving waveform generated by the driver includes a reset period, an address period and a sustain period, and the driving waveforms of the plurality of child waveform modes are driving waveforms changed from at least one of waveforms applied to the plasma display panel during the reset period, the address period and the sustain period for the driving waveform of the parent waveform mode.

10. A driving method of a plasma display device including a plasma display panel driven by a driving waveform applied from a driver controlled by a controller connected to a mode input unit, the driving method comprising:
(a) providing a mode signal for a misdischarge countermeasure mode of the plasma display panel; and
(b) changing the driving waveform from a parent waveform mode into a child waveform mode selected from a plurality of child waveform modes defining misdischarge countermeasure waveforms according to the mode signal.

11. The driving method of a plasma display device as claimed in claim 10, wherein providing the mode signal comprises:
transmitting the mode signal from the mode input unit to a mode setting controller in the controller; and
storing the mode signal in a memory in the mode setting controller.

12. The driving method of a plasma display device as claimed in claim 10, wherein storing the mode signal includes storing the mode signal in a specific address assigned to a microcomputer (MICOM) memory by a MICOM the mode setting controller, the MICOM memory storing the parent waveform mode data in an address of the parent waveform mode and the plurality of child waveform mode data in corresponding addresses of the plurality of the child waveform modes.

13. The driving method of a plasma display device as claimed in claim 12, wherein changing the driving waveform comprises:
changing the parent waveform mode data stored in the address of the parent waveform mode into the selected child waveform mode data corresponding to the mode signal stored in the specific address by the MICOM by turning off and on a power source of the plasma display device;
storing the selected child waveform mode data in a circuit memory of a circuit unit included in the mode setting controller and connected to the MICOM;
generating a control signal for the selected child waveform mode data and transmitting the control signal from the controller to the driver; and
applying a driving waveform generated according to the control signal for the selected child waveform mode data to the plasma display panel.

14. The driving method of a plasma display device as claimed in claim 12, wherein transmitting the mode signal includes transmitting the mode signal directly to the MICOM.

15. The driving method of a plasma display device as claimed in claim 11, wherein storing the mode signal includes storing the mode signal in a receiver memory include in a mode receiver in the mode setting controller.

16. The driving method of a plasma display device as claimed in claim 15, wherein changing the driving waveform comprises:
storing the mode signal in a specific address assigned to an circuit memory of the circuit unit included in the mode setting controller and connected to the mode receiver by turning off and on a power source of the plasma display device, and reading out the mode signal stored in the specific address of the circuit memory and changing the parent waveform mode data stored in the address of the parent waveform mode assigned to the MICOM memory into a child waveform mode data corresponding to the mode signal by the MICOM included in the mode setting controller and connected to the circuit unit;
storing the changed child waveform mode data in the circuit memory of the circuit unit included in the mode setting controller and connected to the MICOM;
generating a control signal for the changed child waveform mode data and transmitting the control signal to the driver by the controller; and
applying a driving waveform generated according to the control signal for the changed child waveform mode data to the plasma display panel by the driver.

17. The driving method of a plasma display device as claimed in claim 15, wherein transmitting the mode signal includes transmitting the mode signal wirelessly to the mode receiver.

18. The driving method of a plasma display device as claimed in claim 10, wherein the driving waveform of the child waveform mode is a driving waveform converted from the waveform applied to the plasma display panel during the reset period, address period and sustain period of at least one subfields of a plurality of subfields divided from one frame for the driving waveform of the parent waveform mode.

19. The driving method of a plasma display device as claimed in claim 10, further comprising identifying whether using a driving waveform of the selected child waveform reduces misdischarge of the plasma display panel.

20. The driving method of a plasma display device as claimed in claim 19, further comprising repeating, using a different mode signal, the changing when misdischarge of the plasma display panel still occurs.
